(19) United States
(12) Patent Application Publication
(10) Pub. No.: US 2002/0015817 A1
(43) Pub. Date: Feb. 7, 2002

(54) Quilted foam pad and method of making same from scrap foam

(76) Inventor: Kenneth Lieblein, Port Washington, NY (US)

Correspondence Address: Waddey & Patterson, P.C., Bank of America Plaza, Suite 2020, 414 Union Street, Nashville, TN, 37219, US

(21) Appl. No.: 09/883,886

(22) Filed: Jun. 18, 2001

Related U.S. Application Data
(63) Continuation-in-part of application No. 09/438,549, filed on Nov. 10, 1999, now abandoned.

(30) Foreign Application Priority Data
Apr. 20, 2000 (US) PCT/US00/10615

(51) Int. Cl. B32B 3/00

(52) U.S. Cl. 428/71

(57) ABSTRACT

A quilted pad is made by chopping post-industrial scrap foam into particles and blowing the chopped particles into an air cyclone. The cyclone separates the particles from the air stream and feeds them into a foam layout machine. The chopped foam particles are deposited across a fabric bottom carrier sheet in a uniform layer. A multi-needle quilting machine lays a top fabric sheet across the foam layer, and then quilts a geometric pattern of pockets which separate and secure the foam particles. The foam particle sheet is then cut into panels and the panel edges are finished, creating a low cost but highly functional and attractive pad that can be used as a cushioning pad internal to a conventional bed mattress, as padding in the manufacture of futons, or as a low cost mattresses for camping, for use in emergency and homeless shelters.

This application is a continuation-in-part under 37 C.F.R. 1.53(b) and claims benefit of co-pending U.S. patent application Ser. No. 09/438,549 filed Nov. 10, 1999, entitled “Quilted Foam Pad and Method of Making Same From Scrap Foam” and International Application Serial No. PCT/US00/10615 filed Apr. 20, 2000, entitled “Quilted Foam Pad and Method of Making Same From Scrap Foam”.

### BACKGROUND OF THE INVENTION

The present invention relates generally to quilted foam pads.

More particularly, this invention pertains to a method of manufacturing of quilted pads by encapsulating chopped particles of post-industrial scrap foam within quilted pockets formed between two layers of fabric.

Quilted pads are commonly used as the top and bottom outer layers in a bed mattress. Conventionally, such pads are manufactured from virgin sheet foam made from polyester, polyurethane, polyurethane or wool. On a limited basis, unfinished pads for ultimate use as top and bottom mattress pads have made from recycled post-industrial scrap foams. Such a recycling line is available in part from Masias Maquinaria, S.A. in Girona, Spain. Referring to such a prior art system 10 in FIG. 1, in a first step in a conventional manufacturing process, large pieces or sheets of scrap polyurethane foam are shredded into particles in a shredding machine 11. The shredded polyurethane particles are then moved through a first particle conduit 12 by the action of a rotary disk condenser 13 to the top of an accumulator 16. The airflow that is associated with the particles passes through a second conduit 14 to a filter 15 where dirt and other undesirable particles are removed. The filtered particles are then deposited into the accumulator 16. The particles are then moved through a third conduit 17 into an automatic layout machine 18 (such as a Masias S.A.D layout system). The conventional layout machine 18 layers the particles on to a continuous fabric carrier sheet. The combination of the carrier sheet and the layer of particles is then moved into a quilting machine 19 where a top fabric sheet and foam sheet are layered over and sewn to the carrier sheet using a quilting pattern applied to the interior portions of the sheet. The quilted product is then rolled up into a continuous sheet roll as shown at 20. At the completion of this prior art method, the pads are unfinished, meaning that they are not properly sized into panels and do not have sewn and finished edges.

The quilting applied by the system 10 is desirable because it separates the resilient material into pockets and creates a more luxurious look and feel. Such features would also be advantageous for lower cost applications, such as for pads used as cushioning layers internal to a conventional bed mattress, as after-market padding to place on top of a conventional bed mattress for extra padding or support, as padding in the manufacture of futons, and as low cost mattresses for camping or emergency and homeless shelters, and the like. In the prior art, such low-cost products have typically been made from non-quilted sheets of polyurethane or polyester fiber, shoddy materials, or other cotton materials. Unfortunately, a conventional quilting recycling line as shown in FIG. 1 is more expensive and less efficient than desired for the manufacture of such products. Further, such systems and end products to date are made almost exclusively from polyurethane scrap foam materials or from a variety of independent fibers, and do not use substantial amounts of scrap materials that have sewn backings. In addition, such prior art systems do not use laminated foam materials or latex, PVC, and/or polyethylene foam materials. Moreover, prior art recycling lines are designed to create a rolled product, requiring further non-automated operations before the end product can be finished.

What is needed, then, is a quilted foam pad suitable for use as an internal mattress cushion or low cost mattress that can be made from a wide variety of recycled post-industrial scrap foam materials, using a manufacturing process that is efficient and low cost.

### SUMMARY OF THE INVENTION

In the quilted foam pad of the present invention, post-industrial scrap foam, including polyurethane, latex, PVC, and polyethylene, with or without a laminated or sewn fabric backing, is chopped into particles having an approximate elongated rectangular shape. The chopped particles are moved by a conveyor and/or a blower system through a conduit to a layout machine. In one embodiment of the invention, the particles are moved through an air cyclone, which uses a rotating column of air to separate the particles from the ambient air, with the air and dust being exhausted upward from the cyclone while the chopped foam particles are sent downward, before being feed into the layout machine.

The layout machine deposits the foam particles onto the inner surface of a continuous fabric bottom carrier sheet, forming a layer of foam of substantially uniform thickness. The bottom carrier sheet with the foam layer is then fed horizontally to a multi-needle quilting machine. The quilting machine and/or the layout machine pulls a top fabric sheet or sheets from a roll and applies it across the layer of foam particles. The quilting machine then sews a pre-determined quilting pattern into the top and bottom sheets, through the layer of foam particles. This encapsulates the foam particles into separate quilted pockets, forming an attractive pattern across the outer surfaces of the top and bottom sheets while maintaining the stability of the foam layer against forces applied during use of the end product. The fabric sheets can be made of cotton, nylon, polyester, vinyl, or polypropylene, woven or non-woven. The continuous sheet of sewn quilted foam is then fed into a panel cutter where the foam sheet is cut into multiple discrete panels of a pre-determined geometry. Finally, the cut panels are moved to a serger table where the edges of the panels are sewn/finished, thereby forming the novel quilted foam pads of the present invention.

### BRIEF DESCRIPTION OF THE DRAWINGS

FIG. 1 is side view of a prior art system for manufacturing top and bottom mattress panels from recycled quilted waste.

FIG. 2 is a side view of the system for manufacturing the quilted foam pads of the present invention.

FIG. 3 is a plan view of the quilted foam mattress pad of the present invention, provided with diamond-shaped quilting pattern.

FIG. 4 is a cutaway side view of the pad of FIG. 3.

FIG. 5 is an oblique view of a typical chopped foam particle used in the manufacture of the pad of FIG. 3.

FIG. 6 is a side view of the system for manufacturing the quilted foam pads of the present invention utilizing an air cyclone.

FIG. 7 is a side view of part of the system for manufacturing the quilted foam pads of the present invention where the system begins with raw material.

FIG. 8 is a side view of part of the system for manufacturing the quilted foam pads of the present invention where the system begins with raw material and includes an air cyclone.

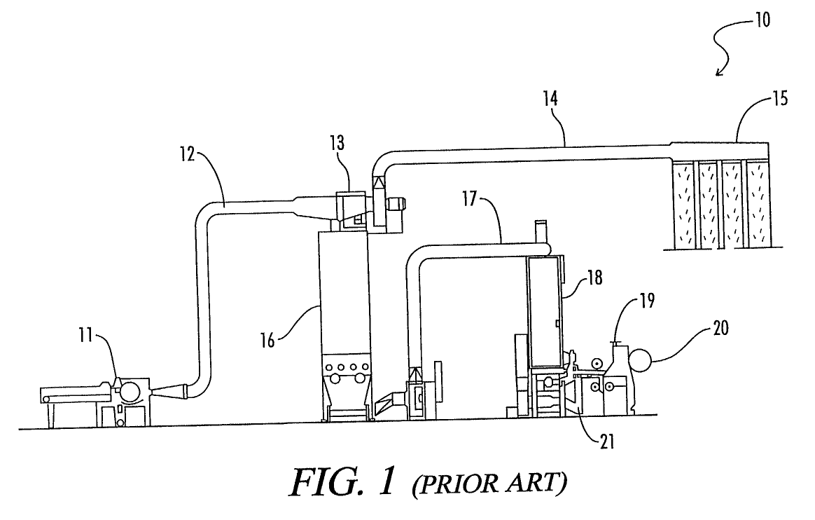

### DESCRIPTION OF THE PREFERRED EMBODIMENTS

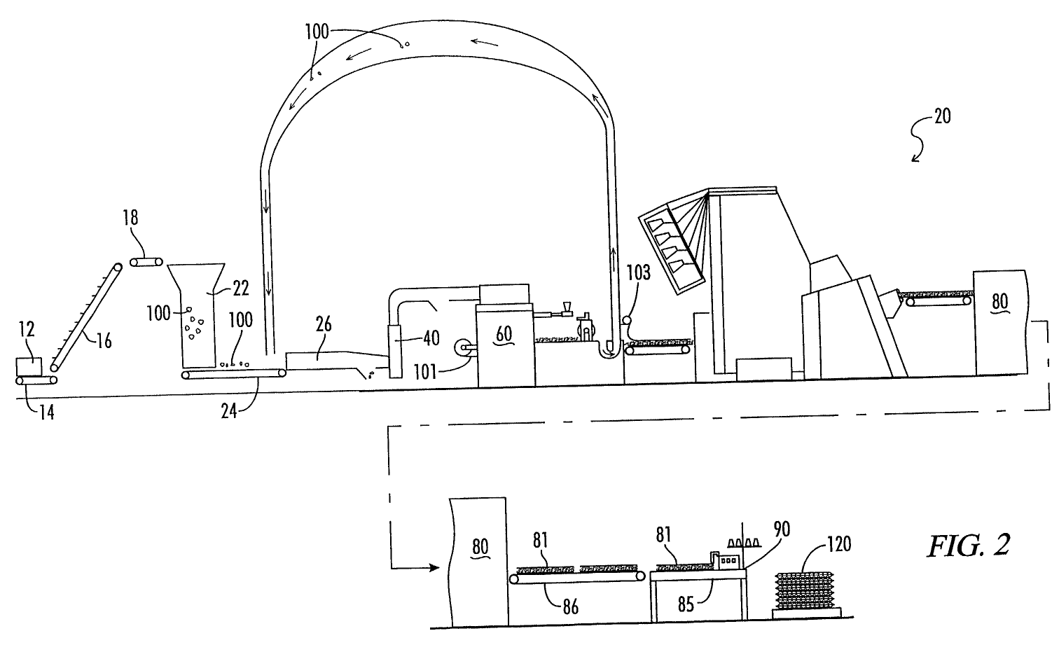

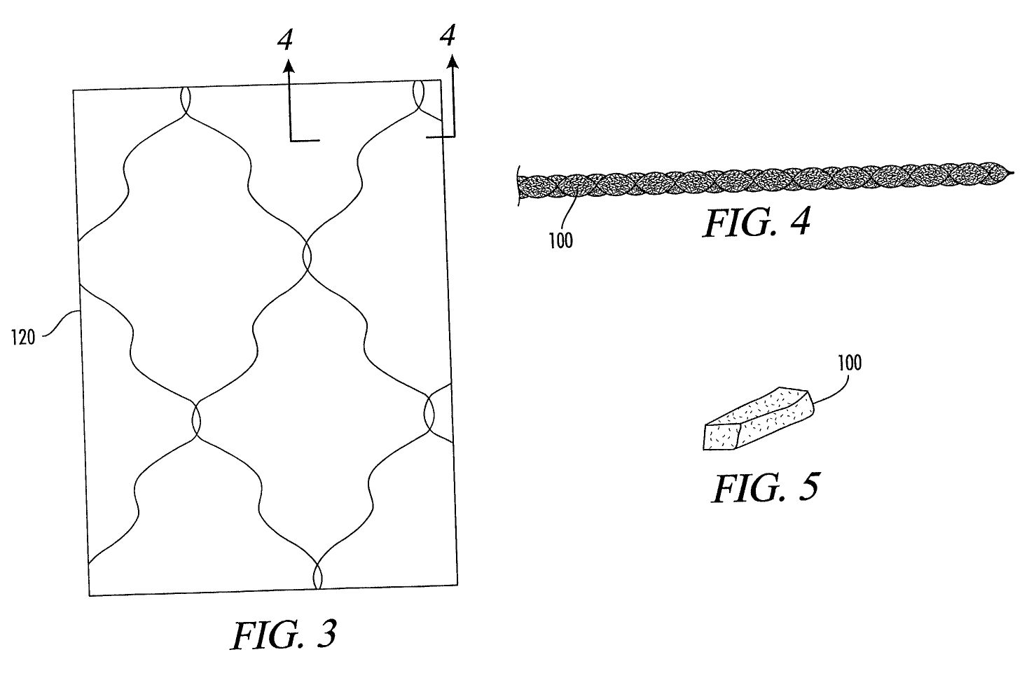

Looking at FIG. 2, a system 20 for manufacturing a quilted foam pad, shown in FIGS. 3 and 4, in accordance with the method of the present invention is shown in side view. The process begins by placing a bale 12 containing chopped foam on a horizontal conveyor 14 which leads to inclined conveyor 16. Conveyor 16 is spiked to grip bale 12. In a preferred embodiment, conveyor 16 is inclined at a 45 degree angle. Inclined conveyor 16 moves bale 12 to conveyor 18 which moves bale 12 into chopped foam bale opener 22. Inside bale opener 22 is a drum (not shown) which has spikes on the outside of the drum. When bale 12 is dropped into bale opener 22, the drum rotates and the spikes break bale 12 into foam particles 100. As shown on FIG. 5, the particles 100 will have a generally elongated rectangular shape, with a length and a width in the range of one-quarter inch to three inches, and a height in the range of one-quarter inch to two inches. The particles 100 are from pieces of post-industrial scrap foam and can have a fabric backing that is sewn or laminated to the back of the pieces of scrap foam. The particles 100 can be made of polyurethane, PVC, latex, polyester, and polyethylene.

In FIG. 2, as foam particles 100 drop past the drum, they pass four magnets (not shown), one on each of the interior walls of the bale opener 22. The magnets separate any magnetic contaminants from the foam particles 100 which fall onto conveyor 24. The portion of conveyor 24 distal bale opener 22 is covered by housing 26 leading to blower 40. The blower 40 is conventional. For example, a Model HV-1 blower from Phelps Fan Manufacturing Co., in Little Rock, Ark. can be used. Inside the top of housing 26 there are additional magnets (not shown) to remove contaminants. Additionally, a debris drop door 30 located in conveyor 24 can be opened to allow heavy contaminants to drop out as foam particles 100 are sucked through housing 26 by blower 40. A debris drop door acts as a gravity filter in a conveyor or conduit, allowing heavy contaminants such as magnetic and non-magnetic metals, wood and plastic to fall away. Foam particles 100 then enter blower 40 and are blown through conduit 45 into layout machine 60. A second debris drop door 47 is located in conduit 45 before layout machine 60.

In a preferred embodiment, all the conduits are constructed from metal to reduce static electricity.

The layout machine 60 is preferably a sheet foam layout machine, such as the Model TA-30 from Masias Maguinaria S.A. of Girona, Spain, that has been adapted to handle foam particles. Such modifications can include: removing the accumulator and standard feed system (and replacing it with the cyclone 50); removing the rotary blades 67 and re-circulating the edge scrap collected through conduit 68 back onto conveyor 24 as shown in FIG. 2; and eliminating the air filtering system.

The chopped foam particles 100 that are deposited into the layout machine 60 are directed by the internal particle feed mechanism (not shown) toward the top surface of a bottom carrier sheet 101 as the sheet is unwound from bottom carrier sheet roll 62 having a width of up to approximately 100 inches. The particles are laid out by layout machine 60 to form a foam particle layer 102 of substantially uniform thickness. Preferably, the foam particle layer 102 can be up to four inches thick, to form a pad 120 having a finished, quilted thickness of approximately one and one-half to two inches.

The carrier sheet 101, now supporting the layer 102 of chopped foam particles 100, is moved forward horizontally by a conveyor 66 from the layout machine 60 into a quilting machine 70. The level plane 200 after conveyor 66 assures no migration of particles during movement from the layout machine 60 to quilting machine 70. At the end of layout machine 60, a top sheet 103 (FIGS. 2, 6, 7 and 8) is unrolled from top sheet roll and layered on top of the foam layer 102. The quilting machine 70 then quilts (sews) the top sheet 103 to the bottom carrier sheet 101 in a quilted pattern through the foam layer 102, while leaving the sheet edges unfinished. Canopy 170 on quilting machine 70 prevents ambient dust from entering the machine. Vacuum tubes (not shown) in quilting machine 70 keep the machine clean.

The quilting of the sheet and carrier combination results in the formation of multiple discrete pockets that encapsulate the foam particles by trapping and isolating groups of the particles from each other. Preferably, a pleasing visible geometric pattern 110 is created on the exterior of the top and bottom sheets 101, 103, such as a repeating arrangement of interlocking diamonds approximately 8″×8″ in size or a wave pattern, although different sizes and shapes can be used.

In a preferred embodiment, the quilting operation is performed by a double chain, multi-needle quilting machine such as the Mammut VMK Chain Stitch Needle Quilter, made by Nahmaschiner-Fabrik Emil Stutznacker BMBH & Co.Kg., of Cologne, Germany. Similar machines are also available from Gribetz International in Sunrise, Fla. This increases the efficiency and speed of the process. The top and bottom sheets 101, 103 are preferably made of cotton, nylon, polyester, vinyl, or polypropylene.

After the quilting operation is complete, the still continuous quilted sheet is fed directly into a conventional panel cutting machine 80. The panel cutting machine 80 cuts the continuous sheet into panels 81 having a pre-determined size and shape corresponding with the particular application for the pads being manufactured. One example of a conventional panel cutting machine that can be used is the Model K-10 Panel Cutter from James Cash of Louisville, Ky. Both Mammut and Gribetz (noted above) also manufacture automated panel cutters.

After the panels are cut, the cut panels 81 are moved by a conveyor 86 or manually placed on a serging table 85 where the ends and sides of the panels 81 are finished by sewing or flanging by a finishing machine 90, such as the GAP3301 Serger-Flanger from Galkin Automated Products, W. Babylon, N.Y. This creates the quilted foam pad 120 of this invention as shown in FIGS. 3 and 4.

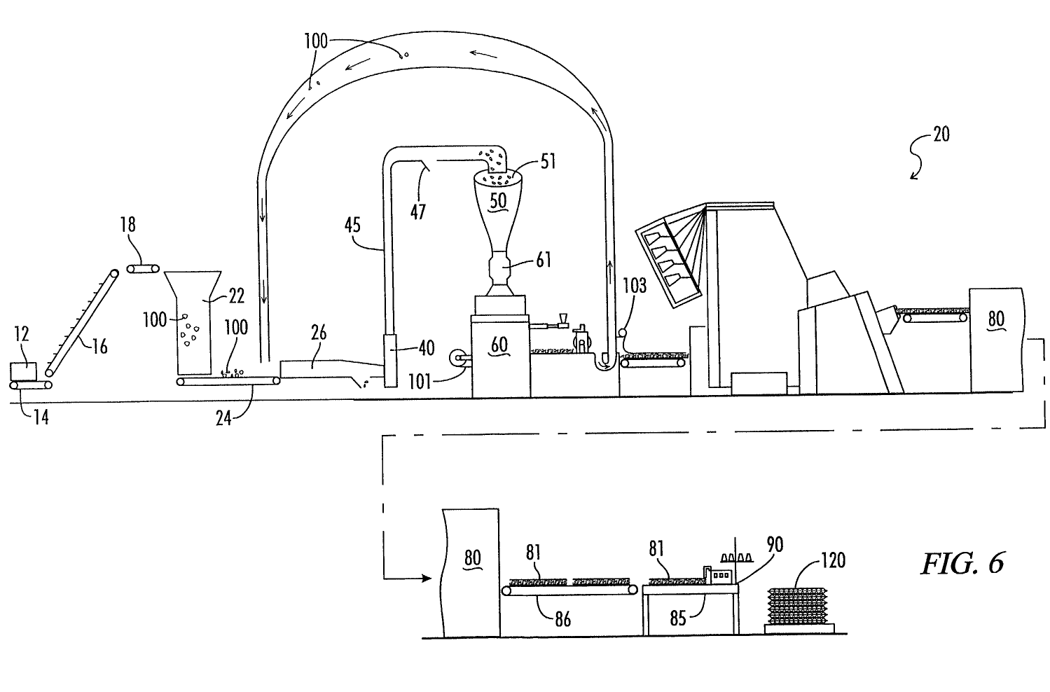

It is also contemplated that an air cyclone could be added to the system to separate dust and air from the foam particles 100. With reference to FIG. 6, air cyclone 50 is added between the blower 40 and the layout machine 60. Blower 40 blows foam particles 100 through conduit 45, past debris drop door 47 and into a particle feed opening 51 of a conventional air cyclone 50. The shape of the air cyclone 50 creates a dynamic flow that functions to separate the foam particles 100 from the air stream. The air is exhausted upward from the cyclone 50 while the particles are moved downward into the feed input 61 of a layout machine 60.

The air cyclone 50 is also conventional, although specifically adapted to interface with layout machine 60. In one embodiment, the cyclone 50 is approximately eleven feet long with a maximum diameter of 44 inches and is capable of feeding particles 100 to the layout machine 60 at a rate of 1500 pounds per hour. Cyclones for this application can be obtained, for example, from B&D Sheet Metal Co., Inc. of Rayville, Tex.

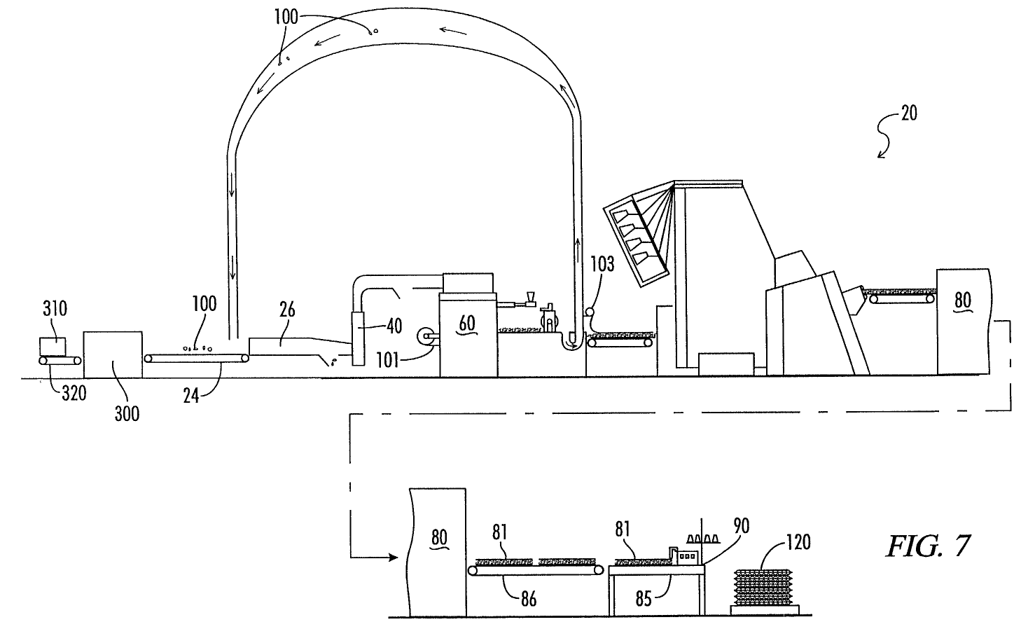

Alternatively, as shown in FIG. 7, system 20 can begin with raw foam material 310 which is placed on conveyor 320 which moves it into grinder 300. Grinder 300 can be a shredding, chopping or grinding machines which shred, chop or grind raw material 310 into particles 100. Grinder 300 can be a silage chopper such as manufactured by Heston Corporation of Maize, Kans. and modified for the purposes of chopping fabric-backed or unbacked foams. A standard rotary grinder, available for example from Cumberland Corporation, S. Attleboro, Mass. can also be used, preferably placed behind a Taylor Stiles cross-cut pre-chopper. Grinder 300 grinds the raw material 310 into foam particles 100 which move onto conveyor 24. The system then continues as described above.

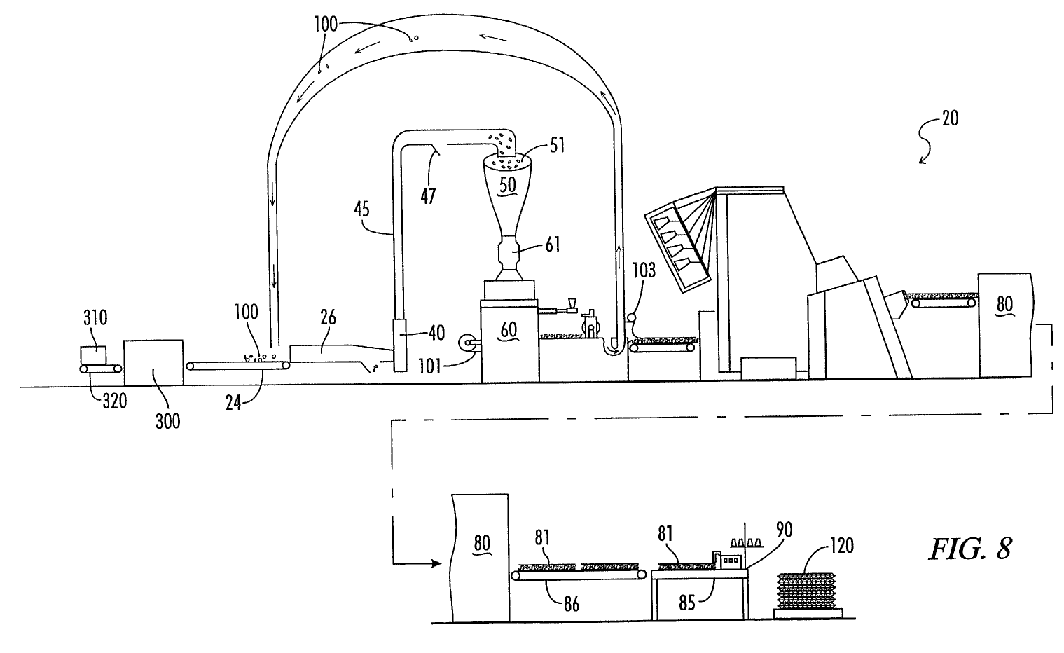

FIG. 8 shows an alternate embodiment of system 20 which begins with raw foam material 310 as shown in FIG. 7 and described above, but also includes air cyclone 50 as shown in FIG. 6 and described above.

Thus, although there have been described particular embodiments of the present invention of a new and useful Quilted Foam Pad and Method of Making Same From Scrap Foam, it is not intended that such references be construed as limitations upon the scope of this invention except as set forth in the following claims.

What is claimed is:

1. A pad comprising a top layer of fabric bonded to a bottom layer of fabric, a layer of recycled foam particles between the top and bottom fabric layers, portions of the layer of foam particles encapsulated by a plurality of pockets formed by sewing the top and bottom fabric layers together in a quilted pattern through the layer of foam particles.

2. The pad of claim 1 wherein the foam particles comprise particles chopped from larger pieces of post-industrial scrap foam materials selected from the group consisting of polyurethane, PVC, latex, polyester, and polyethylene.

3. The pad of claim 2 wherein the pieces of scrap foam material include a fabric backing sewn to the material.

4. The pad of claim 2 wherein the pieces of scrap foam material include a fabric backing laminated to the material.

5. The pad of claim 2 wherein the foam particles have a substantially rectangular shape with a length and a width in the range of one-quarter inch to three inches, and a height in the range of one-quarter inch to two inches.

6. The pad of claim 5 wherein the top and bottom fabric layers comprise a fabric material selected from the group consisting of cotton, nylon, polyester, vinyl, polyurethane, and polypropylene, woven and non-woven.

7. A method of making a quilted pad comprising the steps of:
a. accumulating a plurality of chopped particles of recycled foam material, each of the particles having a size within a pre-determined range;
b moving the foam particles into a layout machine;
c. using the layout machine to deposit the foam particles on to a continuous bottom sheet of fabric forming a substantially uniform layer of the foam particles over the bottom sheet;
d. laying a top sheet over the top of the layer of foam particles.
e. quilting the top sheet to the bottom sheet through the foam layer to form a continuous quilted pad having a pattern of pockets of encapsulated sections of the foam layer;
f. cutting the continuous quilted pad into one or more panels having a predetermined size and shape; and
g. finishing edges of the panels.

8. The method of claim 7 wherein the quilting step is performed by a multi-needle sewing machine.

9. The method of claim 8 wherein the foam particles on the continuous bottom sheet of fabric are moved horizontally into the multi-needle sewing machine.

10. The method of claim 7 wherein the chopped foam particles are moved into the layout machine through an air cyclone.

11. The method of claim 7 wherein the accumulating step includes chopping a bale of chopped foam into foam particles.

12. The method of claim 7 further including the step of separating contaminants from the foam particles with magnets.

13. The method of claim 7 further including the step of removing contaminants from the foam particles with a gravity filter.

14. The method of claim 13 wherein the removing contaminants step is performed by a debris drop door.

15. The method of claim 7 wherein the accumulating step includes chopping raw foam material into foam particles.

16. The method of claim 7 wherein the step of moving the foam particles into the layout machine includes moving the foam particles through an air cyclone to separate the foam particles from the air stream.

17. A system for manufacturing a pad having a top sheet quilted to a bottom sheet through an inner layer of chopped foam particles comprising:
a. air flow means to move the chopped foam particles into an upper region of an air cyclone;
b. the air cyclone having a lower region operatively connected to a feed input of a layout machine, the layout machine operative to deposit the foam particles and form the layer of particles on the bottom sheet;
c. means to move the layer of foam particles and bottom sheet into a quilting machine;
d. the quilting machine operative to quilt the top sheet to the bottom sheet through the layer of foam particles to form a continuous quilted panel having open edges;
e. means to move the continuous quilted panel into a panel cutter;
f. the panel cutter operative to cut the continuous quilted panel into separate quilted panels of a predetermined size; and
g. finishing means to finish the open edges of the separate quilted panels.
